(19) United States
(12) Patent Application Publication
(10) Pub. No.: US 2012/0068377 A1
(43) Pub. Date: Mar. 22, 2012

(54) System and Method for Making Shaped Bands

(75) Inventor: Joshua Malone, Plano, TX (US)

(73) Assignee: TINNUS TECHNOLOGY, LLC, Plano, TX (US)

(21) Appl. No.: 13/221,992

(22) Filed: Aug. 31, 2011

Related U.S. Application Data
(60) Provisional application No. 61/385,075, filed on Sep. 21, 2010.

(51) Int. Cl. B29C 55/00; B28B 7/42

(52) U.S. Cl. 264/292; 249/176

(57) ABSTRACT

A system and method for making shaped bands includes stretching a band into a shape, heating the band to a softening point of a material of the band, and cooling the band to room temperature, such that the band sets into the shape. Other embodiments include an apparatus comprising a pegboard with a plurality of holes, and a plurality of pegs configured to be inserted into corresponding holes from the plurality of holes, wherein the corresponding holes are located at vertices of a shape, and stretching the band around the pegs into the shape. Another embodiment includes attaching the band to a metal wire and bending the metal wire into the shape.

### CROSS-REFERENCE TO RELATED APPLICATION

This application claims the benefit of priority under 35 U.S.C. §119(e) of U.S. Provisional Application Ser. No. 61/385,075, filed Sep. 21, 2010, by Malone, entitled “SYSTEM AND METHOD FOR MAKING SHAPED ELASTIC BANDS,” which is hereby incorporated by reference in its entirety.

### TECHNICAL FIELD

The present disclosure relates generally to hobby craft systems, and more particularly, to a system and method for making shaped bands.

### BACKGROUND

Elastic shaped bands are popular among consumers and are often worn as bracelets, or used as regular rubber bands. Other types of shaped bands, for example, rigid shaped bands, can be used for playing, decorating, building toys and hobby kits, and other purposes. In general, shaped bands are sold in the market in various standard shapes, so consumers can only purchase shapes that are available. Generally, the shaped bands are made in bulk, in factories, using standard shapes on costly equipment, such as injection molding equipment. Presently, there are no suitable, cost-effective methods for consumers to make their own shaped bands conveniently. Therefore, there is a need for a system and method to make shaped bands of any shape in a convenient, cost-effective manner.

### BRIEF DESCRIPTION OF THE DRAWINGS

The present disclosure is best understood from the following detailed description when read with the accompanying figures. The various features are not drawn to scale. In fact, the dimensions of the various features may be arbitrarily increased or reduced for clarity of discussion.

FIG. 1 is a simplified schematic diagram of a system for making shaped bands, according to an embodiment of the present disclosure;

FIG. 2 is a simplified schematic diagram of a system for making shaped bands, according to another embodiment of the present disclosure;

FIG. 3 is a simplified schematic diagram showing additional details of an embodiment according to the present disclosure;

FIG. 4 is a simplified schematic diagram of a system for making shaped bands, according to another embodiment of the present disclosure;

FIGS. 5a and 5b are simplified schematic diagrams showing additional details of an embodiment according to the present disclosure;

FIG. 6 is a simplified block diagram showing an embodiment according to the present disclosure;

FIG. 7 is a simplified flow-chart showing example operational steps associated with embodiments of the present disclosure; and

FIG. 8 is a simplified flow-chart showing example operational steps associated with embodiments of the present disclosure.

### DETAILED DESCRIPTION OF EXAMPLE EMBODIMENTS

### Overview

In accordance with one or more embodiments of the disclosure, systems and methods disclosed herein include stretching an band into a shape, heating the band to a softening point of a material of the band, and cooling the band to room temperature, such that the band sets into the shape.

More specific embodiments include stretching the band around a plurality of pegs inserted into corresponding holes in a pegboard, wherein the corresponding holes are located at vertices of the shape. The pegs may also be inserted into the corresponding holes through a sheet having a plurality of markings that mark the corresponding holes. Heating may be performed by a heat source such as a stove, an oven, a hot air blower, and hot liquid, or an electrical resistance heater proximate to the pegboard.

Other embodiments include attaching the band to a metal wire, and stretching the band into the shape by bending the metal wire into the shape. The band may be overmolded on the metal wire or attached using an adhesive. In various implementations, the band may be elastic and composed of Thermoplastic Elastomer (TPE), Thermoplastic Polyurethane (TPU), Thermoplastic Versalloy (TPV), syndiotactic polystyrene (sPS), styrene-butadiene-styrene (SBS), or polystyrene-b-poly(ethylene-co-butene)-b-polystyrene (SEBS).

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments.

### Example Embodiments

It is to be understood that the following disclosure describes several exemplary embodiments for implementing different features, structures, or functions of the disclosure. Exemplary embodiments of components, arrangements, and configurations are described below to simplify the present disclosure. However, these exemplary embodiments are provided merely as examples and are not intended to limit the scope of the disclosure.

The present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures.

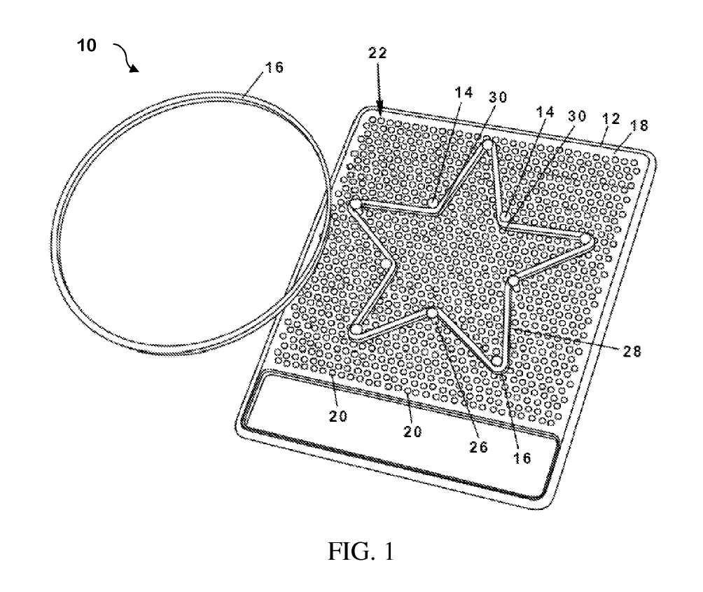

FIG. 1 shows an embodiment of a system 10 for making shaped bands. System 10 comprises a pegboard 12, one or more pegs 14 and an band 16. Pegboard 12 comprises a generally flat board 18 having a plurality of holes 20 on a surface 22. Board 18 may be square, rectangular, circular, or of any other shape. Board 18 may be equipped with one or more handles. Holes 20 are typically circular, but they may also be in oval, rectangular, square, or any other shape.

Pegs 14 may be sized to be inserted into holes 20. In an example embodiment, pegs 14 may be inserted partially into holes 20. When peg 14 is inserted into hole 20, a first end portion of peg 14 may stick out from surface 22, and a second end portion of peg 14 may be disposed within hole 20. The first end portion of peg 14 may have a cross-sectional area that is larger than, or alternatively the same as, the second end portion of peg 14. The first end portion of peg 14 may be spherical and the second end portion of peg 14 may be cylindrical. The first end portion of peg 14 may also have other shapes, for example, disc or prism. The second end portion of peg 14a may be configured to be inserted into one of holes 20. For example, if holes 20 are circular, the second end portion of peg 14 may be cylindrical, or conical. The second end portion of peg 14 may also have other shapes, corresponding to the shape of holes 20.

Holes 20 may be through-holes or blind holes. Holes 20 may be located on surface 22 of board 18. In an example embodiment, holes 20 may be arranged in a pattern. For example, the pattern may comprise an orthogonal grid. In another embodiment, the pattern may comprise an isometric grid. Pegs 14 may be inserted into corresponding holes 20 in pegboard 12. Corresponding holes 20 may be located at vertices of a shape 28. As used herein, “vertices” encompass points along an outline of a shape, for example, points that describe intersections of geometric shapes (e.g., lines), corners, bends, etc. Vertices may correspond to corners of polygons. In the case of a curve, vertices may correspond to points along the curve

In the example embodiment illustrated in FIG. 1, band 16 may be stretched around pegs 14 to form an outline of shape 28. As used herein, “stretching” encompasses any action that causes band 16 to change its original shape, such as threading, looping, bending, twisting, extending, etc. In example embodiments, band 16 may be threaded lightly around pegs 14. In the example illustrated in FIG. 1, shape 28 is a star. Shape 28 may be any shape that can be formed according to the pattern of holes on pegboard 12. Portions 30 of band 16 may be constrained between the first end of each peg 14 and surface 22 of pegboard 12. Band 16 may have any suitable cross-section. For example, band 16 may have a square, rectangular, circular, or oval cross section.

In an embodiment according to the present disclosure, band 16 may include closed rings. In an example embodiment, band 16 may be elastic and made of a thermoplastic material, for example, Thermoplastic Elastomer (TPE), Thermoplastic Polyurethane (TPU), Thermoplastic Versalloy (TPV), syndiotactic polystyrene (sPS), styrene-butadiene-styrene (SBS), or polystyrene-b-poly(ethylene-co-butene)-b-polystyrene (SEBS). Band 16 may also be made of natural and synthetic rubbers (thermosets). In general, pegboard 12 and pegs 14 may be made of materials having melting points greater than a melting point of the thermoplastic material of band 16. In one embodiment, pegboard 12 and pegs 14 may be made of non-metallic materials, for example, wood or plastic, or materials such as Nylon 66, Polycarbonate, ABS, Polycarbonate/ABS blend, cellulose, and phenolic resin. In another embodiment, pegboard 12 and pegs 14 may be composed of metallic materials, for example, steel.

After band 16 has been stretched into shape 28, band 16 may be heated. In an example embodiment, band 16 may be heated to 225° F. When band 16 reaches a softening point of its material, band 16 may soften and/or melt. In an example embodiment, band 16 may be placed in an oven and the oven heated to 225° F. The temperature of the oven may be held at 225° F. for 10 minutes, for example, to permit band 16 to attain the same temperature as the over (e.g., 225° F.). When cooled down, band 16 may set (e.g., freeze) into shape 28 substantially permanently (or until heated again to its softening temperature, depending on its material). After band 16 has cooled down, it may removed from pegboard 12. In an example embodiment, band 16 be elastic after cooling (e.g., band may be stretched as desired and may substantially return to original shape after stretching). In another example embodiment, after cooling, band 16 may be rigid (e.g., inflexible).

Note that the numerical and letter designations assigned to the various elements do not connote any type of hierarchy; the designations are arbitrary and have been used for purposes of teaching only. These designations should not be construed in any way to limit their capabilities, functionalities, or applications in the potential environments that may benefit from the features of system 10. Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

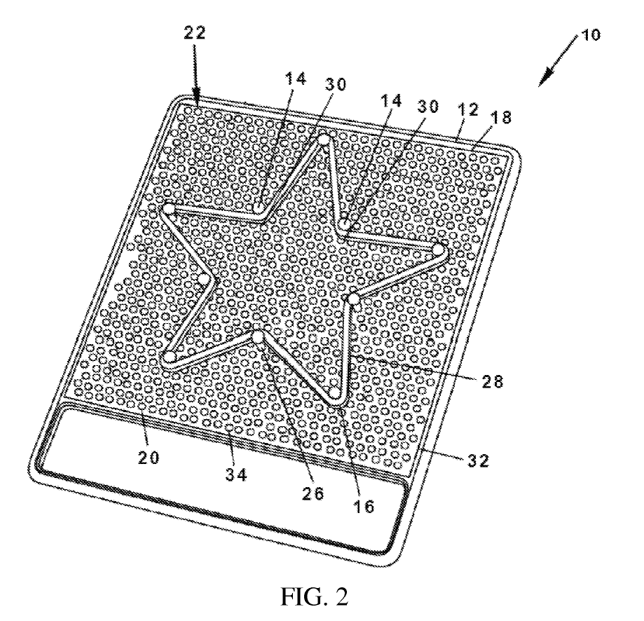

Turning to FIG. 2, FIG. 2 is a simplified schematic diagram of an embodiment of system 10 for making shaped bands. Like components are numbered the same as in FIG. 1. System 10 may comprise pegboard 12, pegs 14, band 16 and a sheet 32. Sheet 32 may be placed on surface 22 of pegboard 12. Sheet 32 may comprise a plurality of markings that mark corresponding holes on pegboard 12 to indicate shape 28. In an embodiment according to FIG. 2, sheet 32 may have a pattern 34 that coincides with a pattern of holes 20 on pegboard 12. Pattern 34 may be drawn, printed or otherwise marked on sheet 32. Pegs 14 may be sized to be inserted partially into holes 20 through sheet 32. Sheet 32 may be made of paper, plastic, cloth, or any other suitable material selected according to particular needs.

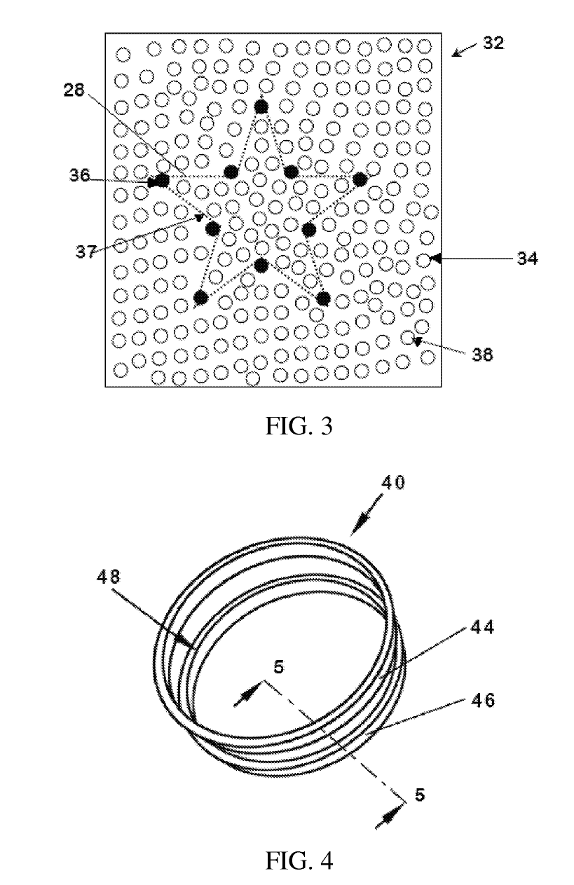

Turning to FIG. 3, FIG. 3 shows additional details of sheet 32 according to an embodiment of the present disclosure. Pattern 34 on sheet 32 may comprise a first set of markings 36, a second set of markings 37 and a third set of markings 38 that may be visually distinct from each other by shape, color and/or form. First set of markings 36 may indicate a location where pegs 14 may be inserted into corresponding holes 20 on pegboard 12 to form shape 28. Third set of markings 37 may indicate an outline of shape 28 that is formed when band 16 is stretched around pegs 14. Second set of markings 36 may comprise all the remaining markings on sheet 32. In example embodiments, second set of markings 36 may be absent. Each shape 28 may be associated with a corresponding sheet 32. Users of system 10 may use sheet 32 as a template or a guide to place pegs according to each shape 28. FIG. 3 shows a star shaped shape 28. It will be appreciated that shape 28 may be of any suitable shape.

In one embodiment, first set of markings 35 may be circles of a darker color than circles comprising second set of markings 36, and third set of markings 37 may be a dotted line connecting the circles of first set of markings 35. Alternatively, first set of markings 35 may comprise circles with holes, second set of markings 36 may comprise circles without holes, and third set of markings 37 may be a line connecting holes of first set of markings 35. Variations in shapes and forms of markings 35, 36 and 37 may be possible without departing from the scope of the present disclosure.

FIG. 4 shows a simplified schematic diagram of an exploded view of an embodiment of a composite band 40 for making shaped bands. Composite band 40 may comprise an band 44 attached to a metal wire 46 along a surface 48. Band 44 may be attached to metal wire 46 by any known means, for example, overmolding, adhesive, etc. Metal wire 46 may be designed so as to be amenable to bending and twisting, such that any desired shape 28 may be formed easily by bending or twisting metal wire 46.

Metal wire 46 may be bent or twisted into a shape using any known method, such as bending with needle nosed pliers. After band 44 has been stretched into shape 28, band 44 may be heated. During heating, band 44 may soften. When cooled down, band 44 may set (e.g., freeze) into shape 28 substantially permanently (or until heated again to its softening temperature, depending on its material). After band 44 has cooled down, it may peeled from metal wire 46. In one embodiment, band 44 may be elastic after cooling (e.g., band may be stretched as desired and may substantially return to original shape after stretching). In another example embodiment, after cooling, band 44 may be rigid.

Turning to FIG. 5, FIGS. 5A and 5B show additional details of cross-section 5-5 of composite band 40 of FIG. 4. According to the example embodiment shown in FIG. 5A, band 44 may be overmolded on metal wire 46. An overlapping surface 48 of metal wire 46 may be of sufficient area to hold band 44 in place over metal wire 46. In an example embodiment, band 44 may be formed around metal wire 46 using any known molding apparatus or method. Choice of metal wire 46 and band 44 may be based on overmolding manufacturing specifications, including adhesive characteristics of a material of band 44 to a metal in metal wire 46.

According to the example embodiment shown in FIG. 5B, band 44 may be attached to metal wire 46 using an adhesive 50. An overlapping surface 48 of metal wire 46 may be of sufficient area to hold band 44 in place over metal wire 46. Adhesive 50 may be any suitable adhesive, selected based on particular needs.

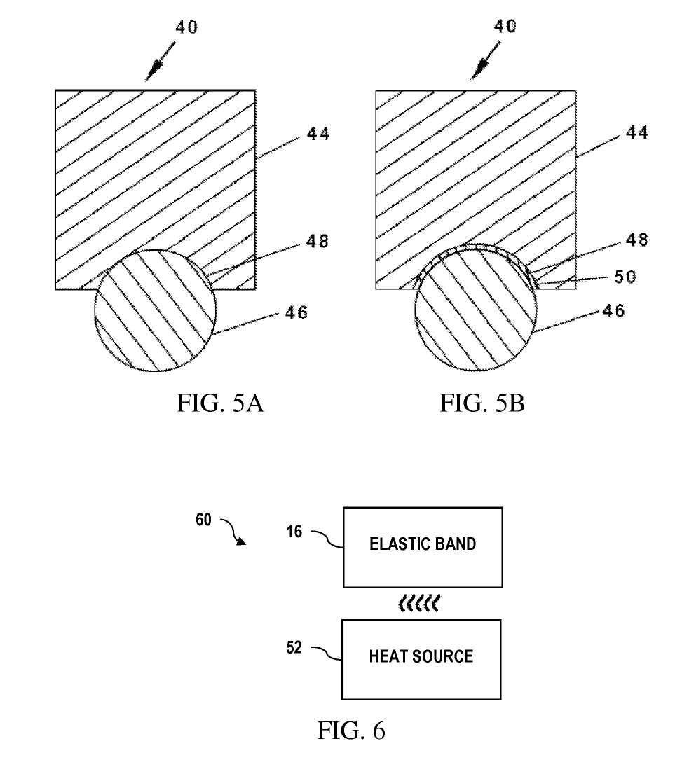

Turning to FIG. 6, FIG. 6 is a simplified block diagram showing an embodiment of system 60 for making shaped bands. A heat source 52 may be used to heat band 16 into a desired shape. In an example embodiment, band 16 may be stretched into a desired shape using pegs 14 or using composite band 44. Band 16 may be heated by heat source 52 until band 16 is softened. When cooled down to room temperature, band 16 may attain a desired shape substantially permanently (e.g., until re-heated).

Heat source 52 may be any known heating apparatus or system, for example, a fire source such as a stove (e.g., grill, electric stove, induction stove, gas stove, etc.), ovens (e.g., convection oven, microwave oven, electric oven, etc.), hot liquids (e.g., running hot water, standing hot water), hot air blower (e.g., hair dryer), and hot solids (e.g., coal, campfire, etc.). In an example embodiment, heat source 52 may be an electrical resistance heater contacting or in close proximity to pegboard 12 and/or pegs 14. In an embodiment, the heat source heat source may be embedded in pegboard 12.

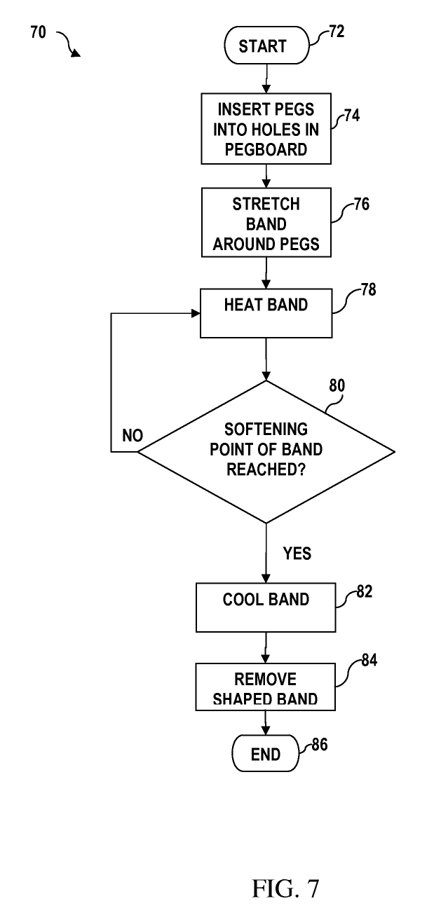

Turning to FIG. 7, FIG. 7 is a simplified flow-chart showing example operational steps that may be associated with embodiments of the present disclosure. Method 70 for making shaped bands starts in step 72, when a desired shape 28 may be selected to create shaped bands. In step 74, pegs 14 may be inserted partially into holes 20 on pegboard 12, for example, at vertices of shape 28. In step 76, band 16 may be stretched around pegs 14 to form an outline of shape 28. If band 16 is composed of a natural or synthetic rubber that requires vulcanization, band 16 may be partially vulcanized prior to stretching it around pegs 14 on pegboard 12. Band 16 may be constrained to pegboard 12 by pegs 14, for example, by frictional forces between band 16 and pegs 14. In step 78, band 16 may be heated to a temperature above a softening point of a material of band 16. The heating may be accomplished using heat source 52.

In step 80, a determination may be made whether the softening point of band 16 has been reached. Softening point is a temperature at which a material softens beyond an arbitrary softness (e.g., defined by viscosity, or some other material property value). For example, according to Vicat softening point test, softening point is the temperature at which a specimen of a material is penetrated to a depth of 1 mm by a flat ended needle with a 1 mm² circular or square cross-section. In general, material data safety sheets (MSDS) of materials may specify the material's softening point. MSDS or similar data sheets containing softening point information, among others, may be used to determine the softening point of band 16.

Such determination may be made with a thermometer, or visually, by looking at the band. In an example embodiment, wherein band 16 is made of Thermoplastic Elastomer, a softening point may be 225° F. If the softening point has not been reached, heating is continued in step 78. In step 82, band 16 may be cooled to room temperature. If band 16 is composed of a natural or synthetic rubber that requires vulcanization, and it has been partially vulcanized prior to stretching, band 16 may be substantially completely vulcanized after the heating and cooling process. In step 84, band 16, now set into shape 28, may be removed from pegboard 12. The process ends in step 86.

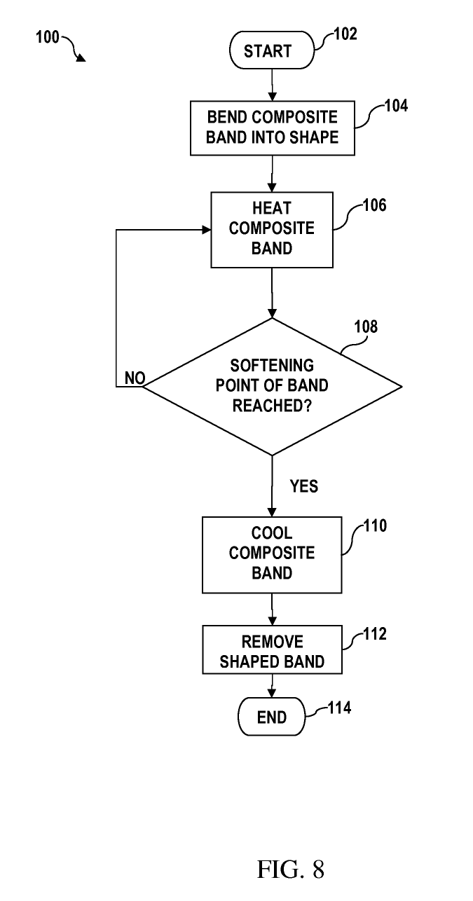

Turning to FIG. 8, FIG. 8 is a simplified flow-chart showing example operational steps associated with embodiments of the present disclosure. Process 100 starts in step 102, when a desired shape 28 may be selected to create shaped bands. In step 104, composite band 40 may be bent or twisted into a desired shape 28 by any known means, for example, with the use of needle-nose pliers. In step 104, composite band 40 may heated to a temperature above the softening point of the material of band 44. The heating may be accomplished using heat source 52.

In step 108, a determination may be made whether the softening point of band 44 has been reached. Such determination may be made with a thermometer, or visually, by looking at the band. If the softening point has not been reached, heating is continued in step 106. In step 110, composite band 40 may be cooled to room temperature. In step 112, band 44 may be removed from composite band 40 using any known method, for example, peeling band 44 from metal wire 46. The process ends in step 114.

While the disclosure references several particular embodiments, those skilled in the art will be able to make various modifications to the described embodiments without departing from the true spirit and scope of the disclosure. It is intended that all elements or steps which are insubstantially different from those recited in the claims but perform substantially the same functions, respectively, in substantially the same way to achieve the same result as what is claimed are within the scope of the disclosure.

What is claimed is:

1. A method comprising:
stretching a band into a shape;
heating the band to a softening point of a material of the band; and
cooling the band to room temperature, such that the band sets into the shape.

2. The method of claim 1, wherein the band is stretched into the shape around a plurality of pegs inserted into corresponding holes in a pegboard, wherein the corresponding holes are located at vertices of the shape.

3. The method of claim 2, wherein the pegs are inserted into the corresponding holes through a sheet, wherein the sheet comprises a plurality of markings that mark the corresponding holes.

4. The method of claim 2, wherein the heating is performed by an electrical resistance heater proximate to the pegboard.

5. The method of claim 2, further comprising removing the band from the pegboard.

6. The method of claim 1, wherein the heating is performed by a heat source selected from a stove, an oven, a hot air blower, and hot liquid.

7. The method of claim 1, wherein the band is elastic and composed of a material selected from Thermoplastic Elastomer (TPE), Thermoplastic Polyurethane (TPU), Thermoplastic Versalloy (TPV), syndiotactic polystyrene (sPS), styrene-butadiene-styrene (SBS), and polystyrene-b-poly(ethylene-co-butene)-b-polystyrene (SEBS).

8. The method of claim 1, wherein the band is elastic after setting into the shape.

9. An apparatus comprising:
a pegboard comprising a plurality of holes; and
a plurality of pegs, such that the apparatus is configured for:
inserting the plurality of pegs into corresponding holes from the plurality of holes, wherein the corresponding holes are located at vertices of a shape;
stretching a band around the plurality of pegs to form an outline of the shape;
heating the band to a softening point of a material of the band; and
cooling the band to room temperature, such that the band sets into the shape.

10. The apparatus of claim 9, further comprising:
at least one band.

11. The apparatus of claim 9, wherein the band is elastic after setting into the shape.

12. The apparatus of claim 9, wherein the band is rigid after setting into the shape.

13. The apparatus of claim 9, further comprising:
a sheet comprising a plurality of markings that mark the corresponding holes.

14. The apparatus of claim 13, wherein the apparatus is further configured for:
inserting the plurality of pegs into the corresponding holes through the sheet.

15. The apparatus of claim 9, wherein the plurality of holes are arranged in a pattern.

16. The apparatus of claim 9, wherein the heating is performed by a heat source selected from a stove, an oven, a hot air blower, hot liquid, and an electrical resistance heater proximate to the pegboard.

17. The apparatus of claim 9, wherein the band is elastic and composed of a material selected from Thermoplastic Elastomer (TPE), Thermoplastic Polyurethane (TPU), Thermoplastic Versalloy (TPV), syndiotactic polystyrene (sPS), styrene-butadiene-styrene (SBS), and polystyrene-b-poly(ethylene-co-butene)-b-polystyrene (SEBS).

18. An apparatus comprising:
at least one band attached to at least one metal wire, such that the apparatus is configured for:
stretching the band into a shape by bending the metal wire into the shape;
heating the band to a softening point of a material of the band; and
cooling the band to room temperature, such that the band sets into the shape.

19. The apparatus of claim 18, wherein the band is overmolded on the metal wire.

20. The apparatus of claim 18, wherein the band is attached to the metal wire using an adhesive.
